(19) United States
(12) Patent Application Publication
(10) Pub. No.: US 2009/0003929 A1
(43) Pub. Date: Jan. 1, 2009

(54) Quick Release System

(76) Inventors: Dickory Rudduck, Chicago, IL (US); Lee David Blattmann, Wilmette, IL (US); Christopher Gerarh Kelliher, Chicago, IL (US)

Correspondence Address: TELEZYGOLOGY, INC., 520 W. ERIE STREET, SUITE 210, CHICAGO, IL, 60654, US

(21) Appl. No.: 11/910,636

(22) PCT Filed: Apr. 3, 2006
(86) PCT No.: PCT/AU06/00439

§ 371 Date: Dec. 14, 2007

(30) Foreign Application Priority Data
Apr. 4, 2005 (AU) 2005901639

(51) Int. Cl. F16B 21/02

(52) U.S. Cl. 403/348

(57) ABSTRACT

The invention relates to a releasable fastening system (10). The releasable fastening system (10) includes a fastening means having a pair of legs (12), at least part of the legs (12) being adapted for movement towards and away from a channel (16) between the legs (12). Each leg (12) has a foot (22) for engagement with external means (track) (26). The releasable fastening system (10) further includes means (wedge) (30) movable in the channel (16) between a locked position in which the feet (22) are in engagement with the external means (track) (26) and an unlocked position in which the feet (22) are disengaged from the external means (track) (26).

### FIELD OF THE INVENTION

This invention is concerned with quick release systems. In the description below, the invention will generally be described with reference to a quick release system for securing and releasing aircraft seats to the body of the aircraft. However, the invention has much wider application and it is to be understood that the context of the description below is for convenience only.

### BACKGROUND OF THE INVENTION

At present, aircraft seats in commercial aircraft are secured by bolts or shear pins inserted through a sub-structure for the seat and into lugs in floor mounts fixed to the aircraft floor. The bolts or shear pins are fastened and retained using nuts. To present a neat and streamlined appearance, the sub-structure is usually covered by a shroud secured between the seat and the sub structure. Because small aircraft have generally little space within which to work and because of the difficulties presented by seat configuration, including the shroud and sub-structure, it can often take up to two hours to unfasten the nuts and bolts in order to remove a single aircraft seat. Since aircraft seats may need to be removed and installed several times during aircraft manufacture and testing, the difficulties encountered in removing seats are a considerable drawback.

In large commercial aircraft, it is often desirable to remove and reinstall aircraft seats. This can be required in order to reconfigure aircraft seat layout, for example, to change the number of first class, business class or economy seats in the aircraft. Reconfiguration can also be required to change the proportion of passenger space to cargo space in an aircraft.

### OBJECT OF THE INVENTION

It is an object of the present invention, at least in some embodiments, to provide a superior system for securing aircraft seats. In some embodiments, the invention aims to provide a sophisticated system for fixing and releasing aircraft seats. In a further enhanced embodiment of the invention, the invention provides a securing and release system which can be controlled from a central location, such as the aircraft control panel or a hand-held computer, and which can enable reports to be provided as to the fastened or unfastened state of the aircraft seat and as to other aspects.

It is also an aim of the present invention, at least in some embodiments, to provide a quick release system which can be useful for aircraft seats, overhead bins and their doors or other storage units and monuments and other applications outside the aircraft industry.

It is anticipated that some embodiments of the present invention, especially when applied to the quick release of seats, can enable commercial aircraft to be quickly reconfigured between different configurations, for example between carrying predominantly economy class passengers and carrying a mixture of economy, business and/or first class passengers, or between carrying predominantly passengers and carrying predominantly cargo. It is an aim to achieve this in considerably less time than possible at present and without usual ergonomic issues.

### DISCLOSURE OF THE INVENTION

Accordingly, the present invention provides a releasable fastening system which includes:
a fastening means including a pair of legs, at least part of the legs being adapted for movement towards and away from a channel between the legs, each leg having a foot for engagement with external means; and
means movable in the channel between a locked position, in which the feet are in engagement with the external means, and an unlocked position, in which the feet are disengaged from the external means.

The pair of legs may be made of any suitable material. Preferably, the pair of legs is part of an aircraft seat frame or storage bin, etc.

The channel may be of any suitable shape. Preferably, the channel includes a flex point located in a part of the channel, possibly at the channel end, remote from the feet. This is to enhance movement of the legs towards and away from the channel. It is further preferred that the channel has a wider dimension in the area of the feet.

The feet may be of any suitable shape. The external means may be a track, for example. In this embodiment, the track preferably includes an inward-facing ledge or inward tapering wall on each side and the feet are designed for engagement beneath the ledges or within the wall when the legs are moved away from the channel. Preferably, the feet include conductive material designed to contact conductive material in the track, to facilitate power and data delivery, as mentioned further below.

The means which are movable in the channel between the locked and unlocked positions preferably takes the form of a wedge. In this embodiment, it is preferred that the channel is wider in the area of the feet and the wedge is dimensioned so that, when it occupies the channel area near the feet, the legs can flex inwardly. When the wedge is pulled further into the channel, into the narrower part of the channel, the wedge is designed to force the legs apart and to engage the feet with the external means.

The moveable means may be caused to move in the channel in any desirable way. In a preferred embodiment, the moveable means is moved by a push-pull actuator. It is further preferred that the push-pull actuator operates through use of material adapted to contract when activated.

While not limiting the scope of such material, it is preferred that the material adapted to contract when activated consists of shape memory alloy wire, Shape memory alloys are known and are usually made predominantly or wholly of titanium and nickel. They may also include other material, such as aluminium, zinc and copper. A shape memory alloy is capable of adopting one shape below a predetermined transition temperature and changing to a second shape once its temperature exceeds the transition temperature. Conversely, when the shape memory alloy cools below the transition temperature, it is capable of adopting the first shape again. In connection with the various aspects of the present invention, the shape memory alloy contracts when heated in situ. Shape memory alloy wire currently available, such as that sold under the name Nitinol, is capable of contracting by about 3% when activated by heating.

Activation of the material adapted to contract when activated is preferably achieved through electrical resistance heating, with a wire feed to the assembly. Activation of the shape memory alloy wire can be initiated from a central location, using the wiring system of, for example, the aircraft, especially utilising a power and data bus. Alternately, power may be supplied by batteries or by induction or any other suitable means.

It is also within the scope of this invention that the activation is initiated by remote means, such as a hand held tool operating through the use of any suitable form of energy, including microwave, magnetic, electro-magnetic, sonic, infra-red, radio frequency and so on.

The scope of the invention in its various aspects is not necessarily limited to the use of shape memory alloy. Other material may also be useful. Also, while activation may take place through heating, other means of activation may be suitable and are within the scope of this invention.

For convenience, the invention will be described below in connection with embodiments of a quick release system for aircraft seats. It is to be understood that the invention is not limited to this application.

In this embodiment, each seat is provided with four brackets as part of the seat frame. Each bracket is designed to be locked into or released from a track. One track may accommodate one forward and rear bracket for the same seat, as well as forward and rear brackets for other seats on the aircraft.

Each bracket includes a pair of legs separated by a channel.

The moveable means is wedge shaped. In one embodiment, the moveable means is caused to move upwardly in a generally vertical direction in order to jam into the channel and deflect the feet into engagement with ledges on the track. Pushing of the wedge downwardly in a generally vertical direction can enable the legs to flex is inwardly, when the channel is wider in the area of the channel in which the wedge will be located. This enables the seat bracket to disengage from the track.

In another embodiment, the wedge is moved into the channel from an open end of the channel, in a generally horizontal direction. Movement of the wedge from a broad part of the channel to a narrow part of the channel will cause the legs to deflect outwardly, to engage the track. Reversal of that movement will allow the legs to flex inwardly, to disengage the track.

In either case, when the seat frame brackets are released, the seat can be caused to slide along the track, or be lifted out.

In this preferred embodiment, the mechanism which causes movement of the wedge means is contained within the seat frame. When the mechanism is actuated, it toggles the wedge means from one position to the other. The mechanism has a pair of carriages, housed one on top of the other. Each carriage houses an actuator made from shape memory alloy wire. When one shape memory alloy wire is powered, it contracts, actuating the mechanism to, say, cause the wedge to travel into the channel so as to lock the bracket to the track. At the same time, the other shape memory alloy wire is rebiased or reset. When the other shape memory alloy wire is powered, it contracts, in this example, causing the wedge means to travel towards the feet of the bracket, unlocking the frame from the track. At the same time, the other shape memory alloy wire is reset.

It is preferred that the “unlock” wire is housed in a carriage which is on top of the carriage which houses the “lock” wire. During operation, the carriages are either moving towards each other or away from each other.

Above, there was mention of the track optically containing power and data delivery means. The feet of the seat brackets may contain means such as sprung conductors which can contact the power and data means in the rail when the seat frame is mounted in the track, so that power and data may be delivered to the seat frame. The electrical contacts are hidden and protected when the seat is located in the track, in this embodiment.

It will be appreciated that inclusion of a continuous bus rail in the track to connect the seat frame into power and data can minimise expensive and heavy cable looms. In a preferred embodiment, the actuation carriages are driven by embedded micro processors. These can have a secondary function in that they can network to a central computer—for example, in the vehicle cockpit—and enable two-way transmission of various types of information or instruction between the seat and a central computer. As one example, information can be transmitted as to whether the seats are locked or unlocked in the tracks. As another example, information as to the amount of weight on a seat can be measured, such as by using stress gauges in the seat frame to provide input into a process, possibly using an algorithm, communicating via the fastener control electronic system to a central computer.

When the fastening system of the invention is used for fastening other elements in the aircraft, such as doors on overhead storage bins, information can be transmitted as to whether the doors are safely closed or not. In addition to the passenger weight, calculation could be made of the weight of luggage in overhead storage compartments. The pilot could then be informed of weight distribution within the aircraft—an important safety aspect, particularly in small aircraft with minimum air crew. A report as to total weight is significant in relation to take-off and landing procedures and also to assist in maintenance schedules. It is within the scope of this invention that weight information is transmitted to an external target, such as a civil aviation authority or other third party, to assist in safety and other issues.

There is a wide range of other possibilities. Reports may be generated as to whether seatbelts are secured. As a further possibility, there may be facility for the pilot to lock seatbelts into position from a central point, or to cause seatbacks to return to the upright position or even to cause tray tables to be stowed. It is within the scope of the invention that the pilot may be able to effect “lock down” of seatbelts, seatbacks and, possibly, tray tables in an appropriate circumstance and to receive a report that lock down has been effected.

In some situations, it is possible that the seat frame may need to be locked into position in the track, to prevent it sliding back and forth within the track, even when the fastening system is locked, For this purpose, it is within the scope of the invention to provide pitched teeth or other means, which engage complementary teeth or grooves on the track. This mechanical interlock can prevent longitudinal movement of the seat frame within the track. Other mechanical locks may be used.

As another option, a secondary locking mechanism may be provided to lock the actuator carriages together, to prevent movement between them. The secondary locking mechanism may be designed to activate when the releasable fastening system is moved to the locked configuration. Various means of locking the carriages may be suitable. A preferred embodiment is a locking pawl biased by a spring, which moves into a groove when the carriages are towards the end of their travel. The locking of the pawl may happen automatically. It can be unlocked when the actuator is fired to proceed to the unlocking configuration. A release pawl can drive towards the locking pawl to release it, to free up motion between the upper and lower actuator carriages.

It is also preferred that, as the upper and lower actuator carriages move away from each other, they can drive out the wedge means in the “horizontal” version of the invention. If the teeth are used to prevent longitudinal motion of the seat frame along the track, this action also causes disengagement of the teeth and frees the seat frame to move along the track. Because the wedge has been driven out of the “locked” position, the legs and feet can flex inwardly out of contact with the track and the seat frame can be slid along the track or lifted out of it.

To avoid possible damage to the shape memory alloy wire, a strain reduction mechanism may be used. Reference is made to International Patent Application No PCT/AU2004/001580, the contents of which are imported herein by reference. In that International application, there is disclosed a strain reduction assembly. The strain reduction assembly includes:
a material adapted to contract when activated, the material having:
   a first pull force at which the material is adapted to move an element to which the material is directly or indirectly connected;
   a second pull force greater than the first pull force; and
   a third pull force intermediate the first pull force and the second pull force; and
means adapted to be activated when the pull force on the material has reached substantially the third pull force.

The means adapted to be activated when the pull force is substantially the third pull force may be a compression spring attached to the material.

The material adapted to contract when activated is preferably the Nitinol wire referred to above. The first, second and third pull forces will depend on the rating of the Nitinol wire. By way of example, if the rating is around 3.3 Newtons, this will represent the first pull force. The second pull force in this example will be around 9 Newtons while the third pull force will be around 4.5 Newtons. Ideally, the third pull force is approximately one and a half times greater than the first pull force and calculated to be less than the second pull force, which may be calculated as that capable of causing damage to the material.

The element to be moved by the material adapted to contract such as the Nitinol wire may be any appropriate element. In the context of the present invention the element is the shuttle.

The compression spring is preferably of any suitable construction.

The means adapted to be activated at the third pull force may take other forms. By way of non limiting example, the means may include monitoring resistance in the Nitinol wire and cutting of electrical power once the resistance has changed by, say, twenty percent.

In the case of either embodiment, the Nitinol wire can be protected from damage;

### BRIEF DESCRIPTION OF THE DRAWINGS

The invention will now be described in connection with certain non-limiting embodiments thereof in connection with the accompanying drawings, in which:

FIG. 1 is a front elevation of a first embodiment of the fastening system of the invention, being of the “vertical” type;

FIG. 2 is a side elevation of the fastening system of FIG. 1 (FIGS. 1 and 2 showing the unlocked position);

FIG. 3 is a front elevation of the fastening system of FIGS. 1 and 2, but showing the locking position;

FIG. 4 is a side elevation of the same embodiment, in the locking position;

FIG. 5 is a side elevation showing a different configuration of seat frame in a track;

FIG. 6 is a plan view of the lower part of the seat frame and track of FIG. 5 and showing a second embodiment of fastener of the invention, being of the “horizontal” type, in the unlocked position;

FIG. 7 is a sectional side view of the embodiment of FIG. 6;

FIG. 8 is an end view of the second embodiment, in the direction of arrow B in FIG. 6; and

FIG. 9 is a cross sectional view taken along the lines C-C of FIG. 6.

### DETAILED DESCRIPTION OF THE DRAWINGS

Referring first to FIGS. 1 to 4, releasable fastening system 10 has a fastening means which includes a pair of legs 12 made of metal, for example, aluminium or titanium, and able to flex at least to some extent around flex point 14. Between legs 12 is channel 16. Channel 16 is wide at flex point 14 and then is of a narrower, constant width as shown at 18, until it widens from point 20. The widest part of channel 16 is between feet 22.

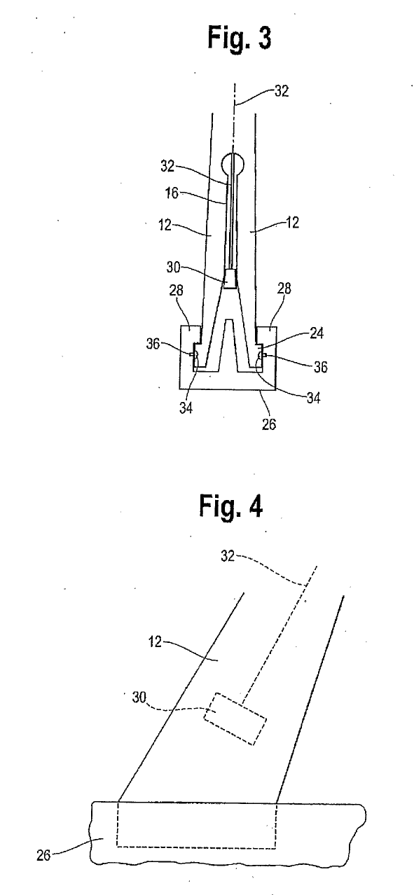

Each foot 22 has an external ledge 24. As can be seen from FIG. 1, external means—track 26—has internal ledges 28. When legs 12 are caused to move outwardly as shown in FIG. 3, each external ledge 24 engages under each internal ledge 28, to lock legs 12 into track 26.

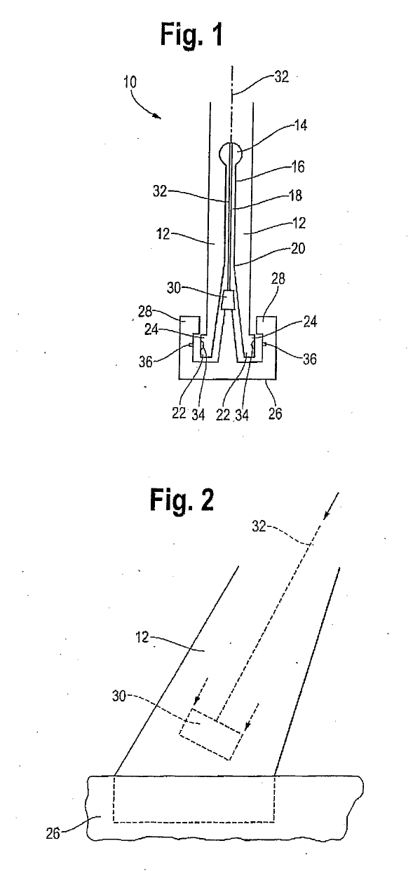

In FIGS. 1 and 2, releasable fastening system 10 is shown in the unlocking position. In this configuration, wedge 30 is being pushed downwardly in channel 16 by a push-pull actuator indicated by shape memory alloy wire 32. The remainder of the push-pull actuator is not shown. As can be seen in FIG. 1, at this stage conductor contacts 34 have not made contact with continuous conductor 36 in track 26.

As shown in FIGS. 3 and 4, as wedge 30 is drawn upwardly in channel 16 by contraction of shape memory alloy wire 32, legs 12 are forced apart and conductor contact 34 is brought into contact with continuous conductor 36. Also as can be seen in FIG. 3, internal ledge 28 of track 26 traps external ledge 24 of leg 12 so that legs 12, being part of a chair frame, are secured within track 26.

It will be appreciated that the track features a vertical continuous spline which can act as an insulator in the event of liquids being spilt into the track.

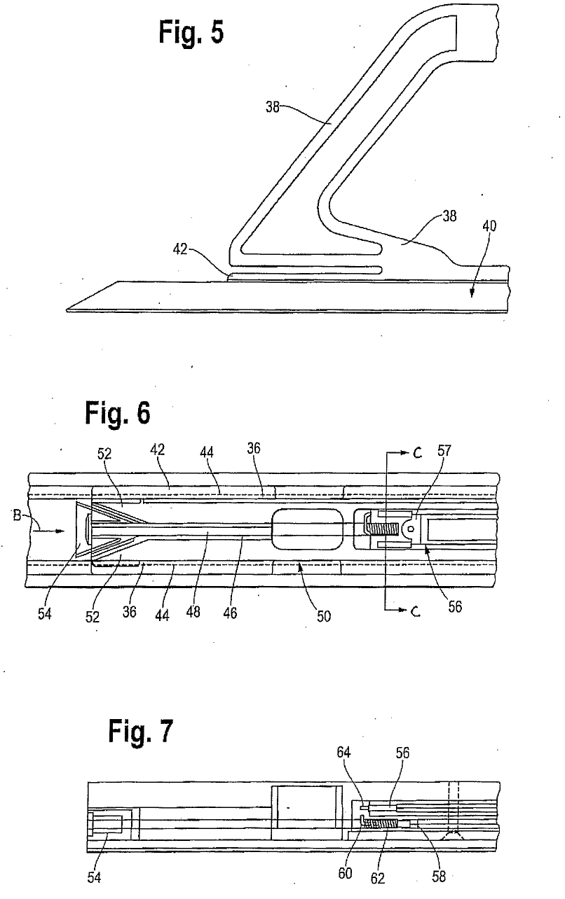

Turning now to FIG. 5, in this embodiment seat base 38 is shown inserted in track 40. In this case, in contrast to the seat leg in FIGS. 1 to 4, base 38 has a horizontal projection 42, part of which fits into track 40.

FIGS. 6, 7 and 8 show the second embodiment of releasable fastener of the 20 invention. It will be seen from FIG. 6 that horizontal projection 42 is divided into two legs 44, with channel 46 between them. Channel 46 is of regular cross-section throughout most of its length, as indicated at 48. Channel 46 widens at flex point 50 and flares out between feet 52.

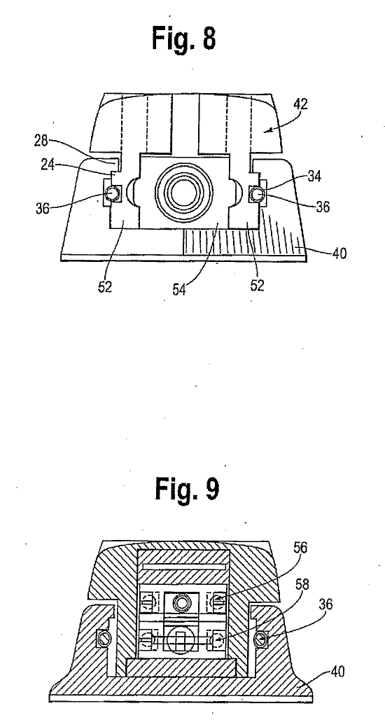

Wedge 54 is inserted horizontally in the wide part of channel 46 between feet 52. As shown in FIG. 6, wedge 54 is not sufficiently within channel 46 to lock feet 52 into track 40, although the locking process has begun As wedge 54 is pulled further into channel 46, legs 44 are forced apart and lock into track 40 as shown in FIG. 8. Internal ledge 28 of track 40 traps external ledge 24 on foot 52 in the locking position.

In a similar manner to the embodiment shown in FIGS. 1 to 4, in the locking position spring conductor contact '34 contacts continuous conductor 36, to provide power and data to seat base 38.

Included in FIG. 6 is a plan view of pull actuator 56. In the side elevation of FIG. 7, it can be seen that pull actuator 56 is in a carriage which is situated above a second carriage containing push actuator 58. Each of actuators 56 and 58 has shape memory alloy wire in a two parallel strand layout. Preferably, the shape memory alloy strands are balanced through strain equaliser mechanism 57, details of which are disclosed in Australian patent application No 2005901640.

It is also preferred that each of actuators 56 and 58 includes a strain reduction assembly as discussed above to reduce the possibility of damage to the shape memory alloy wires.

FIG. 7 shows the secondary locking mechanism which is activated when the system is set to lock. Locking pawl 60 in push actuator 58 is biased by spring 62, so that when pull actuator carriage 56 and push actuator carriage 58 are towards the end of their travel, locking pawl 60 automatically locks into a cavity provided in pull actuator carriage 56. This locks the actuators 56 and 58 together.

Pull actuator carriage 56 includes release pawl 64. When the “unlocking” shape memory alloy wire is activated, release pawl 64 drives towards locking pawl 60 and releases it, freeing up the actuator carriages 56 and 58. These are then able to move away from each other. Wedge 54 is driven out of channel 46. In a preferred configuration, the other end of track 40 (not shown in FIG. 7) will have a corresponding wedge which will also be driven out on unlocking.

If the track and the frame include teeth to prevent longitudinal movement after locking, the teeth are disengaged during the unlocking procedure.

It will be appreciated that actuation of pull actuator 56 will reset push actuator 58 and vice versa.

The strain reduction assembly referred to above may be included in pull actuator 56 and push actuator 58, although not shown in the drawings.

Details of pull actuator 56 and push actuator 58 can also be seen in the section shown in FIG. 9.

### INDUSTRIAL APPLICABILITY

As will be readily appreciated by those skilled in the various arts, the invention disclosed herein is not limited to the examples set out and has wide application in many areas. The invention represents a significant advance in the art of securing and releasing, particularly in connection with aircraft seats and other monuments.

1. A releasable fastening system including:
a fastening means including a pair of legs being integral with a main body, at least part of the legs being adapted for movement towards and away from a channel between the legs, each leg having a foot for engagement with external means; and
means movable in the channel between a locked position in which the feet are in engagement with the external means and an unlocked position in which the feet are disengaged from the external means;
wherein the movable means is movable linearly with respect to the channel.

2. The releasable fastening system of claim 1, wherein the channel includes a flex point located in a part of the channel remote from the feet.

3. The releasable fastening system of claim 1, wherein the channel has a wider dimension in the area of the feet.

4. The releasable fastening system of claim 1, wherein the external means is a track.

5. The releasable fastening system of claim 4, wherein the track includes first and second sides, each of which has an inward-facing ledge or an inward tapering wall.

6. The releasable fastening system of claim 5, wherein each foot is adapted to engage one of the ledges or walls in the locked position.

7. The releasable fastening system of claim 6, wherein each foot includes conductive material adapted to contact conductive material in the track, in the locked position.

8. The releasable fastening system of claim 1, wherein the means moveable in the channel is a wedge.

9. The releasable fastening system of claim 1, wherein the means moveable in the channel is adapted to be moved by a push-pull actuator.

10. The releasable fastening system of claim 9, wherein the push-pull actuator operates through use of material adapted to contract when activated.

11. The releasable fastening system of claim 10, wherein the material includes shape memory alloy wire.

12. The releasable fastening system of claim 10, wherein the material is adapted to be activated through electrical resistance heating.

13. The releasable fastening system of claim 12, wherein the activation is adapted to be initiated from a central location.

14. The releasable fastening system of claim 12, wherein the activation is adapted to be initiated by remote means.

15. The releasable fastening of claim 14, wherein the remote means operates through the use of energy chosen from: microwave, magnetic, eletro-magnetic, sonic, infra-red and radio frequency.

16. The releasable fastening system of claim 9, wherein the push-pull actuator includes a pair of carriages and actuation of one carriage is adapted to reset the other carriage.

17. The releasable fastening system of claim 16, which includes a secondary locking mechanism adapted to lock the pair of carriages together.

18. The releasable fastening system of claim 7, wherein the conductive material in the track is adapted to deliver power and data to each foot in the locked position.

19. The releasable fastening system of claim 18, wherein the conductive material in the track is adapted to enable transmission of information or instruction between the fastening means and the central computer.

20. The releasable fastening system of claim 19, wherein the information includes whether the means moveable in the channel is in the locked or the unlocked position.

21. The releasable fastening system of claim 19, wherein the instruction includes instruction to move the means moveable in the channel to the locked or unlocked position.

22. The releasable fastening system of claim 19, wherein the information includes the amount of weight on the legs.

23. The releasable fastening system of claim 22, wherein the information as to the amount of weight is derived from one or more stress gauges.

24. The releasable fastening system of claim 18, wherein the conductive material in the track is adapted to enable transmission of information or instruction between the fastening means and an external target.

25. The releasable fastening system of claim 24, wherein the information includes the amount of weight on the legs.

26. The releasable fastening system of claim 1, which includes a strain reduction assembly.

27. The releasable fastening system of claim 16, which includes a strain reduction assembly for each carriage.

28. The releasable fastening system of claim 10, which includes a strain equaliser mechanism.

29. The releasable fastening system of claim 1, wherein the main body is an aircraft seat frame or storage bin.

30. The releasable fastening system of claim 29, wherein the external means is a track and the releasable fastening system includes secondary means to lock the legs in the track to prevent longitudinal movement.

31. The releasable fastening system of claim 30, wherein the secondary means includes teeth on the feet adapted to engage teeth or grooves on the track.

32. The releasable fastening system of claim 1, wherein in use the movable means is movable horizontally with respect to the channel.

33. The releasable fastening system of claim 1, wherein in use the movable means is movable vertically with respect to the channel.
